(19) United States
(12) Patent Application Publication
(10) Pub. No.: US 2019/0325861 A1
(43) Pub. Date: Oct. 24, 2019

(54) Systems and Methods for Automatic Speech Recognition Using Domain Adaptation Techniques

(71) Applicants: Maneesh Kumar Singh, Lawrenceville, NJ (US); Aditay Tripathi, Kathua (IN); Saket Anand, New Delhi (IN)

(72) Inventors: Maneesh Kumar Singh, Lawrenceville, NJ (US); Aditay Tripathi, Kathua (IN); Saket Anand, New Delhi (IN)

(21) Appl. No.: 16/387,644

(22) Filed: Apr. 18, 2019

Related U.S. Application Data
(60) Provisional application No. 62/659,584, filed on Apr. 18, 2018.

(51) Int. Cl. G10L 15/16; G10L 15/06; G06N 3/08; G06N 5/04

(52) U.S. Cl. CPC G10L 15/16; G06N 5/046; G06N 3/08; G10L 15/063

(57) ABSTRACT

Systems and methods for automatic speech recognition by training a neural network to learn features from raw speech. The system comprises a neural network executing on a computer system and comprising a feature extractor, a label classifier, and a domain classifier. The feature extractor processes raw speech data and generates a first output data. The label classifier processes the first output data and generates a second output data. The domain classifier processes the first output data and generating a third output data. The neural network calculates first loss data based on the second output, and second loss data based on the third output. Further, the neural network is trained to minimize a cross-entropy cost of the label classifier and to maximize a cross-entropy cost of the domain classifier using the first loss data and the second loss data.

### CROSS-REFERENCE TO RELATED APPLICATIONS

This application claims the benefit of U.S. Provisional Patent Application No. 62/659,584, filed on Apr. 18, 2018, the entire disclosure of which is expressly incorporated herein by reference.

### BACKGROUND

### Technical Field

The present disclosure relates generally to the field of automatic speech recognition. More particularly, the present disclosure relates to systems and methods for automatic speech recognition using domain adaptation techniques.

### Related Art

Speech recognition has long been a subject of interest in the computer field, and has many practical applications and uses. For example, automatic speech recognition systems are often used in call centers, field operations, office scenarios, etc. However, current prior art systems for automatic speech recognition are not able to recognize a wide variety of types of speech from different types of people, such as different genders and different types of accents. Another drawback of prior art systems is that models trained for speech recognition are biased in terms of the training data towards one type of speech. For example, a model might be trained on a database of speech spoken by American readers, and accordingly, might underperform if used with Australian speech. In other words, various accents in speech pose additional difficulties for automatic speech recognition systems.

Moreover, training neural networks for automatic speech recognition becomes challenging when limited amounts of supervised training data is available. In order for acoustic models to be able to handle large acoustic variability, a large amount of labeled data is necessary, which can be expensive to obtain. It is expensive to obtain labeled speech data that contains sufficient variations of the different sources of acoustic variability such as speaker accent, speaker gender, speaking style, different types of background noise or the type of recording device. Prior art systems fall short in mitigating the effects of acoustic variability that is inherent in the speech signal.

Several techniques have been proposed to mitigate the effects of acoustic variability in the speech data. For example, feature space maximum likelihood linear regression, maximum likelihood linear regression (“MLLR”), maximum a posteriori (“MAP”), vocal tract length normalization are all techniques used in generative acoustic models. Also, i-Vectors, learning hidden unit contributions (“LHUC”), Kullback-Leibler (“KL”) divergence regularized, and (deep neural network (“DNN”) acoustic models are adaptation techniques used for discriminative acoustic models. All of these techniques require labeled data from the target domain to perform adaptation, and cannot perform speech recognition using raw speech.

Therefore, in view of existing technology in this field, what would be desirable are systems and methods for automatic speech recognition using raw speech that is invariant to acoustic variability.

### SUMMARY

The present disclosure relates to systems and methods for automatic speech recognition using domain adaptation techniques. In particular, the present disclosure provides the application of adversarial training to learn features from raw speech that are invariant to acoustic variability. This acoustic variability can be referred to as a domain shift. The present disclosure leverages the architecture of domain adversarial neural networks (“DANNs”) which uses data from two different domains. The DANN is a Y-shaped network that consists of a multi-layer convolutional neural network (“CNN”) feature extractor module, a label (senone) classifier, and a domain classifier. The system of the present disclosure can be used for multiple applications with domain shifts caused due to differences in gender and speaker accents.

Further, the systems and methods of the present disclosure achieve domain adaptation using domain classification along with label classification. Both the domain classifier and the label (senone) classifier can share a common multi-layer CNN feature extraction module. The network of the present disclosure can be trained to minimize the cross-entropy cost of the label classifier and at the same time maximize the cross-entropy cost of the domain classifier.

Moreover, the systems and methods of the present disclosure provide for unsupervised domain adaptation on discriminative acoustic models trained on raw speech using the DANNs. Unsupervised domain adaptation can be used to reduce acoustic variability due to many factors including, but not limited to, speaker gender and speaker accent. The present disclosure provides systems and methods where domain invariant features can be learned directly from raw speech with significant improvement over the baseline acoustic models trained without domain adaptation.

### BRIEF DESCRIPTION OF THE DRAWINGS

The foregoing features of the invention will be apparent from the following Detailed Description, taken in connection with the accompanying drawings, in which:

FIG. 1 is a diagram of an embodiment of a neural network of the present disclosure;

FIG. 2 is a drawing illustrating performance of systems when domain shift is present;

FIG. 3 is a diagram illustrating an architecture according to the present disclosure for supervised domain adaption;

FIG. 4 is diagram illustrating hardware and software components of the system of the present disclosure; and

FIG. 5 is a diagram illustrating hardware and software components of a computer system on which the system of the present disclosure could be implemented.

### DETAILED DESCRIPTION

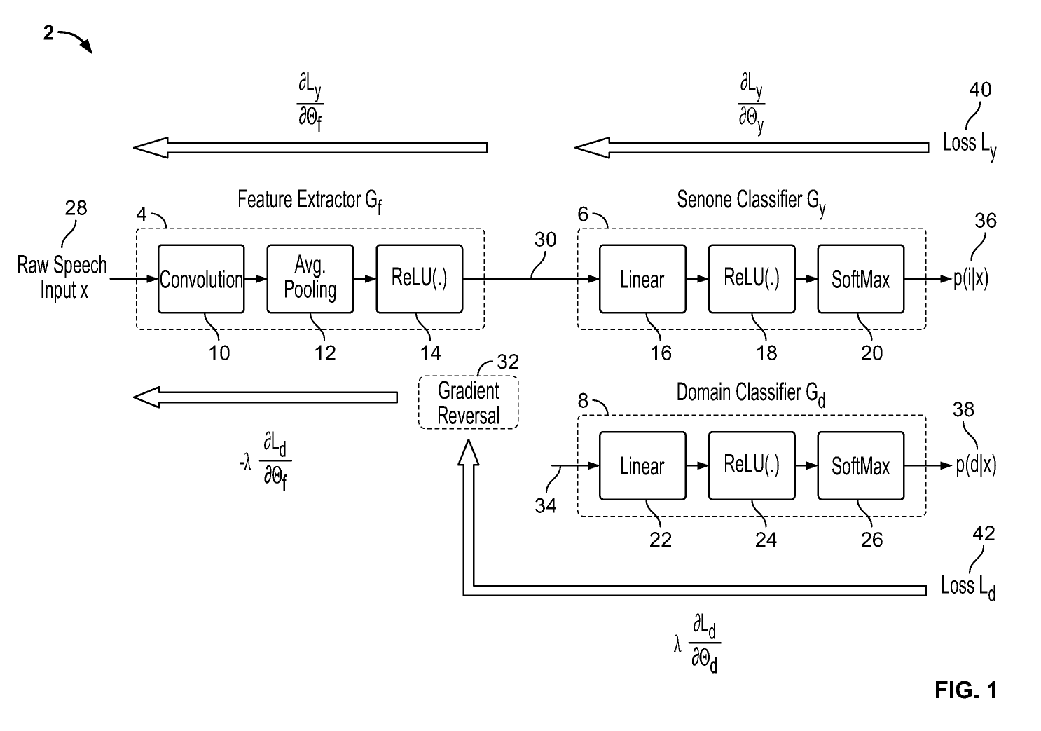

The present disclosure relates to systems and methods for automatic speech recognition using domain adaptation techniques, as discussed in detail below in connection with FIGS. 1-5.

As will be discussed herein, the present disclosure provides unsupervised domain adaptation using adversarial training on raw speech features. The present disclosure can solve classification problems, for example, with an input feature vector space X and Y={0, 1, 2, . . . , L−1} as the set of labels in the output space. S(x,y) and T(x,y) can be unknown joint distributions defined over X×Y, referred to as the source and target distributions respectively. The unsupervised domain adaptation algorithm requires input as the labeled source domain data, sampled from S(x,y) and unlabeled target domain data, sampled from the marginal distribution T(x), as expressed by Equation 1, below:

{(xᵢ,yᵢ)}ᵢ₌₀ⁿ˜S(x,y);{(xᵢ)}ᵢ₌ₙ₊₁^{n+n′=N}˜T(x), Equation 1,

where N=n+n′ is the total number of input samples. As opposed to the class labels, which can be assumed only for the source domain data, binary domain labels (dᵢ={0,1}) are defined as

$${d}_{i} = \{ \begin{matrix}0 for {x}_{i} ∼ S ( x , y ) \\ 1 for {x}_{i} ∼ T ( x ) .\end{matrix}$$

and can be assumed to be known for each sample.

FIG. 1 is a diagram of a neural network architecture 2 in accordance with the present disclosure. The neural network architecture 2 includes a feature extractor 4, a label (or senone) classifier 6, and a domain classifier 8. The feature extractor 4 is a multi-layer convolutional neural network (“CNN”) which includes a convolutional layer 10, an average pooling step 12, and a rectified linear unit (“ReLU”) 14. The label classifier 6 includes a linear step 16, ReLU 18, and a softmax function 20. The domain classifier 8 includes a linear step 22, a ReLU 24 and a softmax function 26. The feature extractor 4 takes raw speech input 28 as input and generates an output 30 which is subsequently processed by the label classifier 6 and the domain classifier 8. As will be explained in greater detail below, a gradient reversal 32 can be used on the output 30 to generate an input 34 to the domain classifier 8. The label classifier generates an output 36 and the domain classifier generates an output 38. The system of the present disclosure can calculate a loss L_{y} based on the output 36 of the label classifier 6 and a loss L_{d} 42 based on the output 38 of the domain classifier 8. At training time, the label classifier's loss can be computed only over labeled samples from S(x,y), whereas the domain classifier's loss can be computed over both, labeled samples from S(x,y) and unlabeled samples from T(x).

The feature extractor G_{f} is a multi-layer CNN and takes the raw speech input vector xᵢ and generates a d-dimensional feature vector fᵢ∈R^{d} given by Equation 2, below:

fᵢ=G_{f}(xᵢ;Θ_{f}), Equation 2

where Θ_{f} can be the parameters of the feature extractor such as weights and biases of the convolutional layers. The input vector xᵢ can be from the source distribution S(x,y) or the target distribution T(x). The 1-d convolution operation in the convolutional layer in the network can be defined by Equation 3, below:

$${f}_{i}^{m , c , 1} = σ ( {\sum }_{j = m}^{m + k - 1} {θ}_{f}^{j - m , c , 1} \cdot {x}_{i}^{j} ) , \qquad Equation 3$$

Equation 3 gives feature vector output at index m from the first layer convolution operation on input feature vector xᵢ, η^{c}_{f}¹ denotes the k-dimensional vector of weights and biases of the first convolutional layer and c^{th} convolutional filter. The function σ(·) is a non-linear activation function like the sigmoid or ReLU.

The label classifier 6 and the domain classifier 8 will now be explained in greater detail. The feature vector fᵢ, which can be extracted from G_{f}, can be mapped to class label yᵢ=G_{y} (fᵢ; Θ_{y}) by the label classifier 6 G_{Y} and to domain label dᵢ=G_{d}(fᵢ; Θ_{d}) by the domain classifier 8 G_{d} as shown in FIG. 1. Both the label classifier 6 and the domain classifier 8 can be multi-layer feed-forward neural networks with parameters collectively denoted as Θ_{f} and Θ_{d} respectively. The unsupervised domain adaptation can be achieved by training the neural network of the present disclosure to minimize cross-entropy based label classification loss on the labeled source domain data and at the same time to maximize cross-entropy domain classification loss on the supervised source domain data and unsupervised target domain data. The classification losses can be the cross-entropy costs. The total loss can be represented by Equation 4, below:

$$E ( {Θ}_{f} , {Θ}_{y} , {Θ}_{d} ) = {\sum }_{i = 1. . N , {d}_{i} = 0} {L}_{y} ( {G}_{y} ( {G}_{f} ( {x}_{i} ; {Θ}_{f} ) ; {Θ}_{y} ) , {y}_{i} ) - λ {\sum }_{i = 1. . N} {L}_{d} ( {G}_{d} ( {G}_{f} ( {x}_{i} ; {Θ}_{f} ) ; {Θ}_{d} ) , {d}_{i} ) . \qquad Equation 4$$

The parameter λ can be a hyper-parameter that weighs the relative contribution of the two costs. To simplify, Equation 4 can be written in a simpler form as shown by Equation 5, below:

$$E ( {Θ}_{f} , {Θ}_{y} , {Θ}_{d} ) = {\sum }_{i = 1. . N , {d}_{i} = 0} {L}_{y}^{i} ( {Θ}_{f} , {Θ}_{y} ) , - λ {\sum }_{i = 1. . N} {L}_{d}^{i} ( {Θ}_{f} , {Θ}_{d} ) . \qquad Equation 5$$

The label classifier 6 can minimize the label classification loss L_{y}ⁱ (Θ_{f}, Θ_{y}) on the data from source distribution S(x,y). Accordingly, the label classifier 6 can optimize the parameters of both feature extractor (Θ_{f}) and label predictor(Θ_{y}). By doing so, the system of the present disclosure can ensure that the features fᵢ can be discriminative enough to perform good prediction on samples from the source domain. At the same time, the extracted features can be invariant enough to the shift in domain. In order to obtain domain invariant features, the parameters of feature extractor Θ_{f} can be optimized to maximize the domain classification loss Ly L_{y} (Θ_{f} Θ_{d}) while, at the same time, domain classifier Θ_{d} can classify the input features. In other words, the domain classifier of the trained network can be configured to not be able to correctly predict the domain labels of the features coming from the feature extractor.

The desired parameters Θ\hat{ }_{f}, Θ\hat{ }_{y}, Θ\hat{ }_{d} can provide a saddle point during a training phase and can be estimated as follows:

$$\begin{matrix}( \hat{{Θ}_{f}} , \hat{{Θ}_{y}} ) = arg {min}_{{Θ}_{f} , {Θ}_{y}} E ( {Θ}_{f} , {Θ}_{y} , \hat{{Θ}_{d}} ) \\ \hat{{Θ}_{d}} = arg {max}_{{Θ}_{d}} E ( \hat{{Θ}_{f}} , \hat{{Θ}_{y}} , \hat{{Θ}_{d}} ) .\end{matrix}$$

The model (e.g., the neural network) can be optimized by the standard stochastic gradient descent (hereinafter “SGD”) based approaches. The parameter updates during the SGD can be defined as follows:

$$\begin{matrix}{Θ}_{f} ← {Θ}_{f} - μ \{ \frac{\partial {L}_{y}^{i}}{\partial {Θ}_{f}} - λ \frac{\partial {L}_{d}^{i}}{\partial {Θ}_{f}} \} \\ {Θ}_{y} ← {Θ}_{y} - μ \frac{\partial {L}_{Y}^{i}}{\partial {Θ}_{y}} \\ {Θ}_{d} ← {Θ}_{d} - μ \frac{\partial {L}_{d}^{i}}{\partial {Θ}_{d}} .\end{matrix}$$

where, η is the learning rate. The above equations can be implemented in a form of SGD by using a special Gradient Reversal Layer (hereinafter “GRL”) at the end of feature extractor 6 and at the beginning of domain classifier 8 as can be seen in FIG. 1. During the backward propagation, GRL can reverse the sign of gradients, multiply them with the parameter λ and pass it onto the subsequent layer, while in forward propagation GRL can function as an identity transform. At the test time, the domain classifier and the GRL can be disregarded. The data samples can be passed through the feature extractor and label classifier to obtain the predictions.

Implementation and testing of the system of the present disclosure will now be explained in greater detail. The TIMIT and Voxforge datasets can be used to perform domain adaptation experiments. For TIMIT speech corpus, domain adaptation can be performed by taking male speech as source domain and female speech corpus as target domain. For the Voxforge corpus, domain adaptation can be performed by taking American accent and British accent as source domain and target domain respectively and vice-versa. For TIMIT speech corpus, male and female speakers can be separated into source domain and target domain datasets. TIMIT is a read speech corpus in which a speaker reads a prompt in front of the microphone. It includes a total of 6,300 sentences, 10 sentences spoken by each of the 630 speakers for 8 major dialect regions of the United States of America. It includes a total of 3,696 training utterances sampled at 16 kHz, excluding all SA utterances because they can create a bias in the dataset. The training set consists of 438 male speakers and 192 female speakers. The core test set is used to report the results. It includes 16 male speakers and 8 female speakers from all of the 8 dialect regions. For the Voxforge dataset, American accent speech and British accent speech can be taken as two separate domains. Voxforge is a multi-accent speech dataset with 5 second speech samples sampled at 16 KHz. Speech samples can be recorded by users with their own microphones which allows quality to vary significantly among samples. Voxforge corpus has 64 hours of American accent speech and 13.5 hours of British accent speech totaling to 83 hours of speech. Results can be reported on 400 utterances each for both the accents. Alignments can be obtained by using HMM-GMM acoustic model trained using Kaldi as known by those of skill in the art. The present disclosure is not limited to any dataset or any of the parameters discussed above and below for testing, implementation and experimentation.

Raw speech features can be obtained by using a rectangular window of size 10 milliseconds on raw speech with a frame shift of 10 milliseconds. A context of 31 frames can be added to windowed speech features to get a total of 310 milliseconds of context dependent raw speech features. These context dependent raw speech features can be mean and variance normalized to obtain final features.

The feature extractor can be a two-layer convolutional neural network. The first convolutional layer can have a filter size of 64 with 256 feature maps along with the step size of 31. The second convolutional layer can have a filter size of 15 with 128 feature maps and step size of 1. After each convolutional layer, an average-pool layer can be used with a pooling size of 2 and a ReLU activation unit. Both the label classifier 6 and the domain classifier 8 can be 4 layer and 6 layer fully connected neural networks with ReLU activation unit and a hidden unit size of 1024 and 2048 for TIMIT and Voxforge, respectively. The weights can be initialized in a Glorot fashion. The model can be trained with SGD and with momentum as known by those of skill in the art. The learning rate can be selected during the training using formula

$${μ}_{ρ} = \frac{μ o}{{( 1 + α * p )}^{β}}$$

where p increases linearly from 0 to 1 as training progresses, μo=0.01 ηo=0.01, a=10, and β=0.75. A momentum of 0.9 can also be used. The adaptation parameter λ can be initialized at 0 and is gradually changed to 1 according to the formula

$${λ}_{ρ} = \frac{2}{1 + exp ( - γ * p )} - 1 ,$$

where 7 is set to 10 as known by those of skill in the art. Domain labels can be switched 10% of the time to stabilize the adversarial training. The present disclosure is not limited to any specific parameter or equation or dataset as noted above.

The results of testing of the system will now be discussed in greater detail. The tests specifically study the acoustic variabilities like speaker gender and accent using TIMIT and Voxforge speech corpus, respectively. Due to possible insufficient labeled female speech data in TIMIT corpus domain adaptation, tests can be performed only for male speech as the source domain and female speech as target domain. Tests can be performed by taking the American accent as the source domain and the British accent as the target domain and vice versa. Additional tests can also be performed by training the acoustic model on the labeled data from both the domains which can function as the lower limit for the achievable WER. In the tables below, DANN represents the domain adapted acoustic model using labeled data from the source domain and unlabeled data from the target domain and NN represents the acoustic model trained on the labeled data from the source domain only.

Table 1 below shows a percentage PER for acoustic model trained on supervised data from source domain and unsupervised data from target domain for TIMIT corpus taking male speech as the source and female speech as the target.

TABLE 1

| Labeled source | Unlabeled | Test | | |
|---|---|---|---|---|
| data | target data | data | NN | DANN |
| Male + Female | | Male | 21.25 | |
| Male + Female | | Female | 23.21 | |
| Male | Female | Male | 24.63 | 25.37 |
| Male | Female | Female | 37.20 | 32.26 |

The first two rows in Table 1 list the PER results for the acoustic model trained on labeled data from both the domains with no domain adaptation. This acoustic model can provide effective results and can be the lower limit for the PER. Rows 3 and 4 of Table 1 provide the acoustic model trained on labeled data from the male speech and adapted using unlabeled data from female speech. Specifically, row 3 indicates the effect of domain adaptation on the performance on data from source domain which is male speech in this case. Row 4 gives the PER for the un-adapted and adapted acoustic models for data from target domain which is female speech in this case.

TABLE 2

| | Unlabeled | | | |
|---|---|---|---|---|
| Labeled source data | target data | Test data | NN | DANN |
| American + British | | American | 10.87 | |
| American + British | | British | 15.01 | |
| American | British | American | 11.50 | 16.53 |
| British | American | British | 18.41 | 19.62 |
| American. | British | British | 28.11 | 23.10 |
| British | American | American | 23.37 | 23.16 |

Table 2 above shows a percentage of WER for acoustic models trained on supervised data from the source domain and unsupervised data from the target domain for Voxforge dataset taking American and British accents as two different acoustic domains.

TABLE 3

| | Unlabeled | | | |
|---|---|---|---|---|
| Labeled source data | target data | Test data | NN | DANN |
| American + British | | American | 18.83 | |
| American + British | | British | 20.10 | |
| American | British | American | ?? | 18.42 |
| British | American | British | ?? | 18.21 |
| American. | British | British | ?? | 31.64 |
| British | American | American | ?? | 26.42 |

Table 3 above shows a percentage of WER for acoustic models trained on supervised data from the source domain and unsupervised data from the target domain for the Voxforge dataset taking American and British accents as two different acoustic domains for MFCC features. Rows 1 and 2 in Table 3 are the WER values for the acoustic model trained on labeled data from both the domains and without any domain adaptation. These values can correspond to the lower limit for the WER for both the domains. Rows 3 and 4 represents the effect of domain adaptation on the performance of the acoustic model on the data from source domain which is American and British respectively. The corresponding NN values are the WER for the acoustic model trained on labeled data from the same domain only. Rows 5 and 6 show the WER for target domain data on un-adapted and adapted acoustic models.

Table 4 below shows further results of the system of the present disclosure.

TABLE 4
$PER / WER / CER = \frac{\# deletions + \# insertions + \# substitutions}{Total number of words in transcription} * 100$

| Source | Target | Features | DANN | NN |
|---|---|---|---|---|
| Male Speech | Female Speech | MFCC | 31.37 | 33.82 |
| Male Speech | Female Speech | Raw Speech | 32.26 | 37.2 |

The following discussion expresses performance in terms of absolute increases or decreases in WER with respect to the baseline models. With reference to Table 1, the acoustic variability due to speaker gender is evident with a 12.57% increase in PER for the acoustic model trained on male speech and tested for both the male and female speech as shown in rows 3 and 4 in Table 1 against NN column. The domain adapted acoustic model, which is trained on labeled male speech as the source domain and unlabeled female speech as the target domain, performs better than the un-adapted model as shown in last row of Table 1. Domain adaptation using adversarial training succeeded in learning gender invariant features which leads to significant improvement over the acoustic model trained on the male speech only. In some cases, the model can be trying to learn domain invariant features which may lead to the sacrifice of domain specific features. Good performance for the female speech can be achieved when the labeled female speech is used alongside the labeled male speech to train the acoustic model. The speaker accent can also be a major source of acoustic variability in the speech signal. This is evident in the degradation in performance of the source only acoustic model on the target domain as compared to performance on source domain. The degradation is 16.61% for the American accent only acoustic model and 4.96% for British accent only acoustic model as shown in Table 3. The corresponding accent adapted acoustic models see an improvement for American target and British target domains respectively. In some cases, a loss of domain specific features during domain adversarial training can impact the results. Moreover the best performance on the target domain is achieved for the acoustic model trained on labeled data from both the domains.

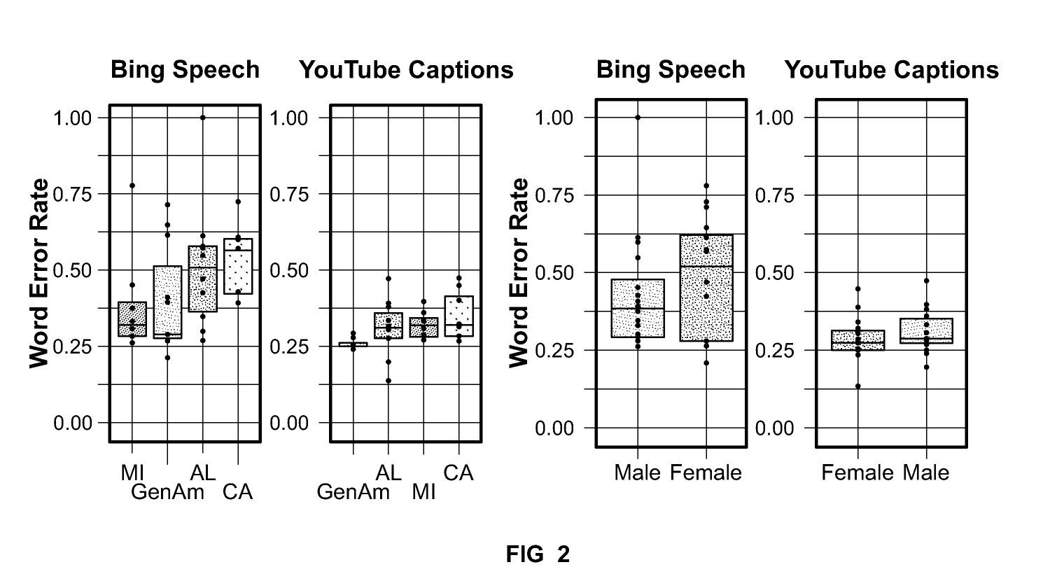

The foregoing tests and results show that unsupervised domain invariant features learning directly from raw speech using domain adversarial neural networks is an effective method of automatic speech recognition. As can be seen in FIG. 2, domain shift can adversely affect performance of prior art automatic speech recognition systems, which the system of the present disclosure solves for these deficiencies. In particular, unsupervised domain adaptation can be achieved by using an additional domain classifier along with the regular senone classifier and forcing the network during training to learn features from raw speech that are sufficiently discriminative for the senone classifier and invariant enough to fool the domain classifier. The systems and methods of the present disclosure also shows that there is significant acoustic variability present in the speech signal due to change in speaker gender and accent. The systems and methods of the present disclosure can be used for domain adaptation using adversarial training to learn domain invariant features which can be supported by the experiments on male and female speech domains in TIMIT corpus and American and British accent domains in Voxforge corpus.

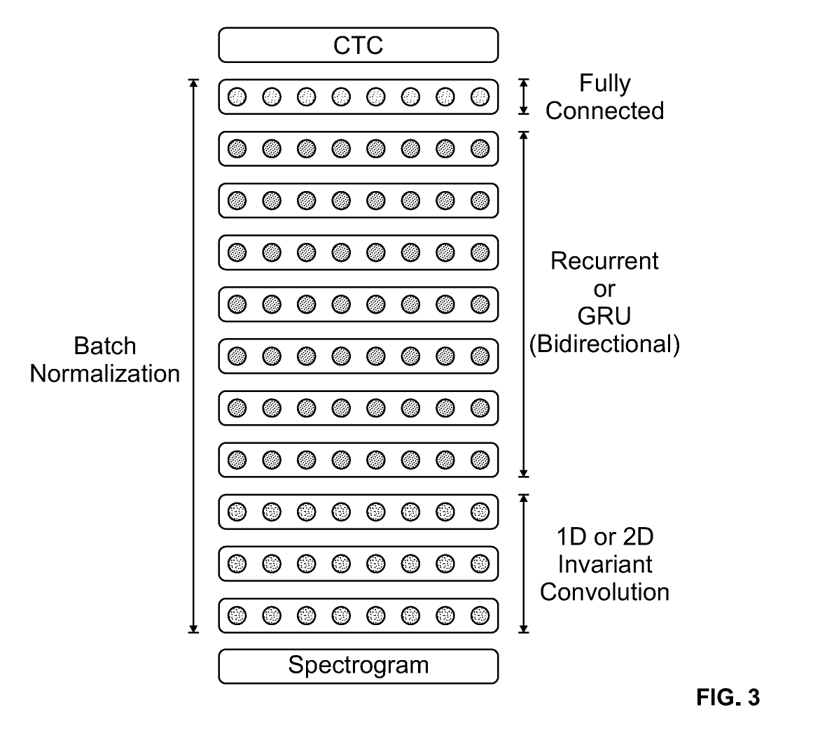

FIG. 3 is a diagram illustrating an architecture in accordance with the present disclosure for supervised domain adaption. As can be seen, FIG. 3 can include a deep speech architecture. The domain can be accent, or any other domain as known in the art. A plurality of layers can be included in the middle of a CTC and a spectrogram. The layers can be batch normalization layers. The layer proximal to the CTC can be fully connected and a plurality of layers below the CTC can be recurrent or GRU (bi-directional). A plurality of other layers proximal to the spectrogram can be 1D or 2D invariant convolution as shown in FIG. 3. A source domain used in this architecture can be American speech such as Librispeech dataset having 1,000 hours of labelled data. The target domain can be Australian speech (AusTalk dataset with approximately 2 hours of unlabeled data). The methodology can be training on large labeled source domain of the American speech. The fine tuning can be done on the small labeled target domain such as the Australian speech in this example. Any model architecture can be adopted in this embodiment of the present disclosure. Experimental results of the present disclosure can be shown in Table 5 below:

TABLE 5
Supervised Domain Adaptation

| | | Performance | | |
|---|---|---|---|---|
| Source | Target | Criteria(%) | Adapted | Un-adapted |
| American | Australian | CER | 8.482 | 24.488 |
| Accent | Accent | | | |
| American | Australian | WER | 18.604 | 60.028 |
| Accent | Accent | | | |

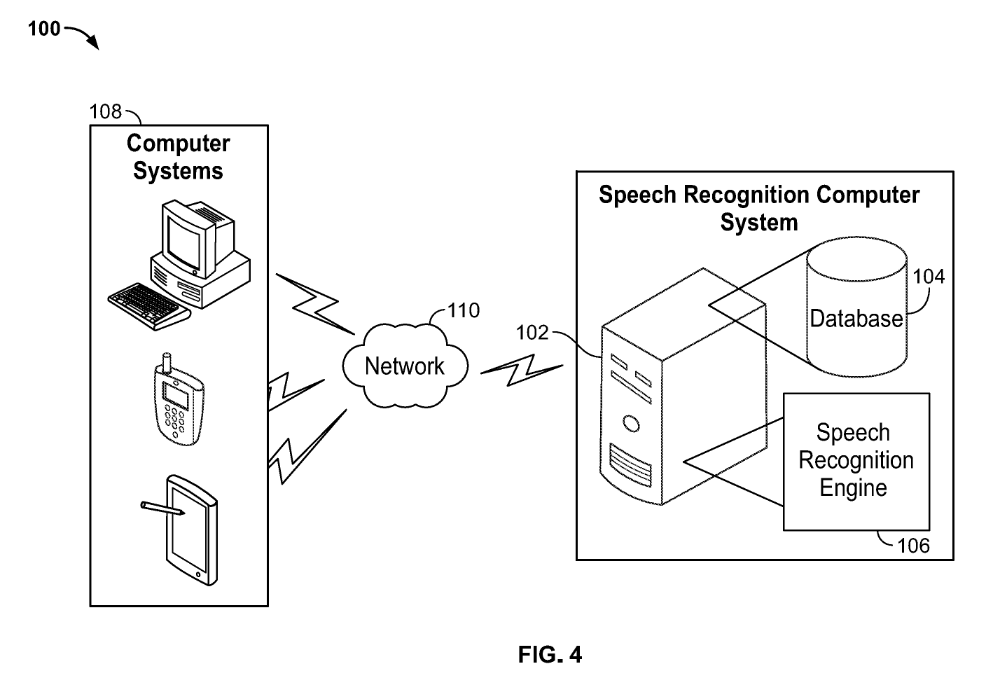

FIG. 4 is diagram illustrating hardware and software components of the system of the present disclosure. A system 100 can include a speech recognition computer system 102. The speech recognition computer system can include a database 104 and a speech recognition processing engine 106. The system 100 can also include a computer system(s) 108 for communicating with the speech recognition computer system 102 over a network 110. Network communication could be over the Internet using standard TCP/IP communications protocols (e.g., hypertext transfer protocol (HTTP), secure HTTP (HTTPS), file transfer protocol (FTP), electronic data interchange (EDI), etc.), through a private network connection (e.g., wide-area network (WAN) connection, emails, electronic data interchange (EDI) messages, extensible markup language (XML) messages, file transfer protocol (FTP) file transfers, etc.), or any other suitable wired or wireless electronic communications format. The computer system 108 can also be a smartphone, tables, laptop, or other similar device. The computer system 108 could be any suitable computer server (e.g., a server with an INTEL microprocessor, multiple processors, multiple processing cores) running any suitable operating system (e.g., Windows by Microsoft, Linux, etc.). Input speech to be processed by the system can be acquired by the computer systems 108 (e.g., using microphones of such systems), and processed by the engine 106. It is noted that the processing engine 106 could execute on any of the computer systems 108, if desired.

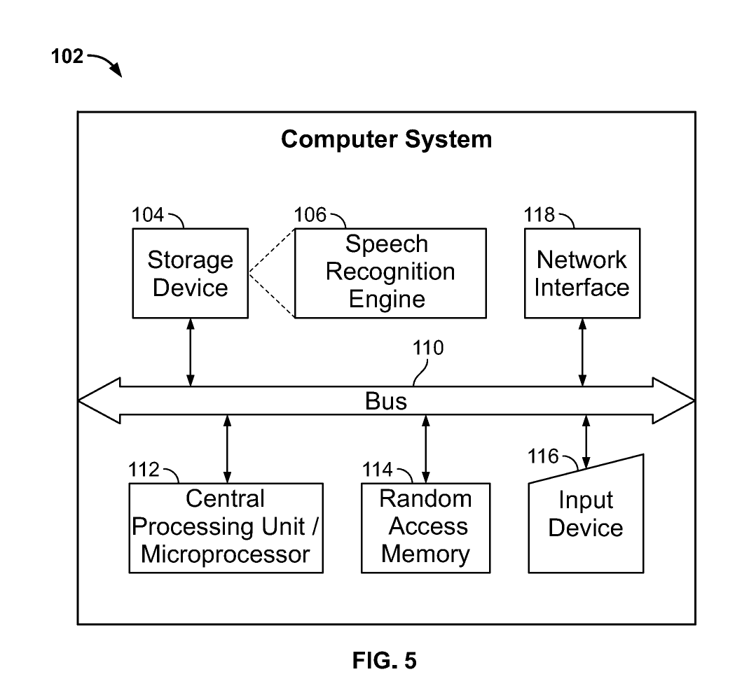

FIG. 5 is a diagram illustrating hardware and software components of a computer system on which the system of the present disclosure could be implemented. The system 100 comprises a processing server 102 which could include a storage device 104, a network interface 118, a communications bus 110, a central processing unit (CPU) (microprocessor) 112, a random access memory (RAM) 114, and one or more input devices 116, such as a keyboard, mouse, etc. The server 102 could also include a display (e.g., liquid crystal display (LCD), cathode ray tube (CRT), etc.). The storage device 104 could comprise any suitable, computer-readable storage medium such as disk, non-volatile memory (e.g., read-only memory (ROM), erasable programmable ROM (EPROM), electrically-erasable programmable ROM (EEPROM), flash memory, field-programmable gate array (FPGA), etc.). The server 102 could be a networked computer system, a personal computer, a smart phone, tablet computer etc. It is noted that the server 102 need not be a networked server, and indeed, could be a stand-alone computer system. The functionality provided by the present disclosure could be provided by an automatic speech recognition program/engine 106, which could be embodied as computer-readable program code stored on the storage device 104 and executed by the CPU 112 using any suitable, high or low level computing language, such as Python, Java, C, C++, C#, .NET, MATLAB, etc. The network interface 108 could include an Ethernet network interface device, a wireless network interface device, or any other suitable device which permits the server 102 to communicate via the network. The CPU 112 could include any suitable single- or multiple-core microprocessor of any suitable architecture that is capable of implementing and running the automatic speech generation program 106 (e.g., Intel processor). The random access memory 114 could include any suitable, high-speed, random access memory typical of most modern computers, such as dynamic RAM (DRAM), etc. The input device 116 could include a microphone for capturing audio/speech signals, for subsequent processing and recognition performed by the engine 106 in accordance with the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is intended to be protected by Letter Patent is set forth in the following claims.

1. A system for automatic speech recognition by training a neural network to learn features from raw speech, comprising:
a neural network executing on a computer system and comprising a feature extractor, a label classifier, and a domain classifier, wherein:
the feature extractor processes raw speech data and generates a first output data;
the label classifier processes the first output data and generates a second output data;
the domain classifier processes the first output data and generating a third output data;
the neural network calculates first loss data based on the second output, and second loss data based on the third output; and
the neural network is trained to minimize a cross-entropy cost of the label classifier and to maximize a cross-entropy cost of the domain classifier using the first loss data and the second loss data.

2. The system of claim 1, further comprising a gradient reversal layer, wherein, prior to the domain classifier processing the first output data, the gradient reversal layer processes the first output data and feeds the processed first output data into the domain classifier.

3. The system of claim 2, wherein the gradient reversal layer uses a standard stochastic gradient descent based approach to process the first output data.

4. The system of claim 1, wherein the feature extractor is a multi-layer convolutional neural network (“CNN”) comprising a convolutional layer, an average pooling step, and a rectified linear unit (“ReLU”).

5. The system of claim 1, wherein the label classifier comprises a linear step, a ReLU, and a softmax function.

6. The system of claim 1, wherein the domain classifier comprises a linear step, a ReLU, and a softmax function.

7. The system of claim 1, wherein the system computes the first loss over labeled samples.

8. The system of claim 1, wherein the system computes the second loss over labeled samples and unlabeled samples.

9. The system of claim 1, wherein the label classifier optimizes one or more parameters of the feature extractor and the label predictor using the first loss data.

10. The system of claim 9, wherein the one or more parameters are used as a saddle point during training of the neural network.

11. A method for automatic speech recognition by training a neural network to learn features from raw speech, comprising:
processing raw speech data via a feature extractor and generating a first output data;
processing the first output data via a label classifier and generating a second output data;
processing the first output data via a domain classifier and generating a third output data;
calculates first loss data based on the second output and second loss data based on the third output; and
training a neural network to minimize a cross-entropy cost of the label classifier and to maximize a cross-entropy cost of the domain classifier using the first loss data and the second loss data.

12. The method of claim 11, further comprising processing the first output data via a gradient reversal layer prior to step of processing the first output data, and feeding the processed first output data into the domain classifier.

13. The method of claim 12, wherein the gradient reversal layer uses a standard stochastic gradient descent based approach to process the first output data.

14. The method of claim 11, wherein the feature extractor is a multi-layer convolutional neural network (“CNN”) comprising a convolutional layer, an average pooling step, and a rectified linear unit (“ReLU”).

15. The method of claim 11, wherein the label classifier comprises a linear step, a ReLU, and a softmax function.

16. The method of claim 11, wherein the domain classifier comprises a linear step, a ReLU, and a softmax function.

17. The method of claim 11, wherein the first loss is computed over labeled samples.

18. The method of claim 11, wherein the second loss is computed over labeled samples and unlabeled samples.

19. The method of claim 11, further comprising optimizing one or more parameters of the feature extractor and the label predictor using the first loss data.

20. The method of claim 19, wherein the one or more parameters are used as a saddle point during the training of the neural network.
